(19) United States
(12) Patent Application Publication
(10) Pub. No.: US 2009/0273647 A1
(43) Pub. Date: Nov. 5, 2009

(54) INKJET PRINT HEAD AND MANUFACTURING METHOD THEREOF

(75) Inventors: Myong Jong KWON, Suwon-si (KR); Sung Joon Park, Suwon-si (KR); Moon Chul Lee, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/274,456

(22) Filed: Nov. 20, 2008

(30) Foreign Application Priority Data
Apr. 30, 2008 (KR) 2008-40617

(51) Int. Cl. B41J 2/05; B23P 17/00

(52) U.S. Cl. 347/63; 29/890.1

(57) ABSTRACT

An inkjet print head includes a substrate formed with a feed hole through which ink is transferred, and a notch prevention layer covering an area on the substrate where the feed hole is to be formed. Plasma electrons flown into the feed hole while the hole is formed on the substrate through dry etching can move through the notch prevention layer. As a result, corrosion of the substrate around the feed hole by the electrons can be prevented, thereby achieving a uniform width of the feed hole.

### CROSS-REFERENCE TO RELATED APPLICATIONS

This application claims priority under 35 U.S.C. §119(a) from Korean Patent Application No. 2008-0040617, filed on Apr. 30, 2008, in the Korean Intellectual Property Office, the disclosure of which is incorporated herein in its entirety by reference.

### BACKGROUND OF THE INVENTION

1. Field of the Invention

The present general inventive concept relates to an inkjet print head and a manufacturing method thereof, and more particularly to an inkjet print head equipped with a feed hole to feed ink, and a manufacturing method thereof.

2. Description of the Related Art

Generally, an inkjet print head is an apparatus that forms an image by jetting micro droplets of printing ink onto desired positions of a recording paper.

The inkjet print head includes a substrate including a jetting pressure generating device formed on a surface of the substrate to generate an ink jetting pressure, a path layer deposited on the substrate to form ink paths through which ink is supplied, and a nozzle layer deposited on the path layer and equipped with a nozzle to emit ink.

Such an inkjet print head, according to a conventional art, is manufactured by preparing the substrate, forming a thin film lamination deposited on the substrate to generate the ink jetting pressure, depositing the path layer including the ink paths on the thin film lamination, depositing a sacrifice layer in the ink paths, depositing the nozzle layer equipped with the nozzle on the path layer, forming a feed hole at the substrate through dry etching, and finally removing the sacrifice layer.

In the above-structured conventional inkjet print head, however, there is a problem in that notches may be generated at the substrate when forming the feed hole through dry etching. More specifically, after the feed hole is formed on the substrate, electrons in a form of plasma that flown into the feed hole can not penetrate the sacrifice layer formed of resin, and therefore corrode the feed hole adjoining parts of the substrate which is in contact with the sacrifice layer, thereby incurring the notches. When the notches are generated, a width of the feed hole may be varied according to positions.

In addition, while forming the feed hole on the substrate through dry etching, the notches may increase as the dry etching is continued, thus increasing the width of the feed hole. Therefore, in order to restrain an excessive increase of the feed hole width, the dry etching time needs to be restricted to shorter than a predetermined time.

### SUMMARY OF THE INVENTION

The present general inventive concept provides an inkjet print head to prevent variation of a feed hole width incurred by notches generated on a substrate at parts around the feed hole while the feed hole is being formed at the substrate through dry etching, and a manufacturing method thereof.

The present general inventive concept also provides an inkjet print head to guarantee an enough time for the dry etching for formation of the feed hole, and a manufacturing method thereof.

Additional aspects and/or utilities of the present general inventive concept will be set forth in part in the description which follows and, in part, will be obvious from the description, or may be learned by practice of the general inventive concept.

The foregoing and/or other aspects and utilities of the general inventive concept may be achieved by providing an inkjet print head including a substrate formed with a feed hole through which ink is transferred, and a notch prevention layer to cover an area on the substrate where the feed hole is to be formed.

The notch prevention layer may have a greater width than the feed hole.

Furthermore, a thin film lamination may be formed on the substrate, including a penetration hole having a greater width than the feed hole, and the notch prevention layer is formed on the substrate within a range of the penetration hole.

The thin film lamination may comprise a heat generating layer to generate heat, and an electrode layer to supply power to the heat generating layer, and the notch prevention layer is formed simultaneously with the electrode layer.

The thin film lamination may comprise a heat generating layer to generate heat, and an anti-cavitation layer to protect the heat generating layer, and the notch prevention layer is formed simultaneously with the anti-cavitation layer.

The notch prevention layer may have a width corresponding to the feed hole that will be formed at the substrate.

The notch prevention layer may have thickness in a range of 500 Å to 10,000 Å.

The notch prevention layer may be formed of a conductive material.

The notch prevention layer may comprise any one of Ta, Al, and a conductive resin.

The foregoing and/or other aspects and utilities of the general inventive concept may also be achieved by providing an inkjet print head including a substrate formed with a feed hole through which ink is transferred, a thin film lamination formed on the substrate, including at least one conductive layer, and a notch prevention layer formed with the conductive layer to cover an area on one side of the substrate where the feed hole is to be formed.

The foregoing and/or other aspects and utilities of the general inventive concept may also be achieved by providing a manufacturing method of an inkjet print head, the method including preparing a substrate, forming a notch prevention layer on the substrate, and forming a feed hole through the substrate and the notch prevention layer through dry etching.

Here, a thin film lamination including at least one conductive layer may be formed on the substrate, and the notch prevention layer is formed along with the conductive layer.

The thin film lamination includes a penetration hole to form a path, and the notch prevention layer is formed on the substrate within a range of the penetration hole.

The forming of the thin film lamination may include depositing an electrode layer which is a conductive layer, and the notch prevention layer may be formed along with the electrode layer.

The forming of the thin film lamination may include depositing an anti-cavitation layer which is a conductive layer, and the notch prevention layer may be formed along with the anti-cavitation layer.

When the feed hole is formed on the substrate, the notch prevention layer may be formed in a width corresponding to the feed hole.

The notch prevention layer may be removed after the feed hole is formed.

The foregoing and/or other aspects and utilities of the general inventive concept may also be achieved by providing a manufacturing method of an inkjet print head, the method including forming a thin film lamination including at least one conductive layer, on a substrate, forming a notch prevention layer along with the conductive layer, and forming a feed hole through dry etching on an area of the substrate where the notch prevention layer is formed.

The feed hole may be formed on the substrate, and a hole having a width corresponding to the feed hole is formed on the notch prevention layer.

The foregoing and/or other aspects and utilities of the general inventive concept may also be achieved by providing an inkjet print head including a notch prevention layer to allow electrons to pass therethrough during formation of a feed hole having a width substantially uniform all over, and a substrate having an area in which the feed hole is formed.

The notch prevention layer may cover the area of the substrate in which a feed hole is to be formed.

The foregoing and/or other aspects and utilities of the general inventive concept may also be achieved by providing a method of manufacturing an inkjet print head, the method including forming a notch prevention layer on a portion of a substrate in which an ink feedhole is to be formed, the notch prevention layer including a material in which plasma electrons can pass therethrough, and forming an ink feedhole through dry etching where the notch prevention layer is formed such that notches are not formed in the feedhole.

### BRIEF DESCRIPTION OF THE DRAWINGS

These and/or other aspects and utilities of the exemplary embodiments of the present general inventive concept will become apparent and more readily appreciated from the following description of the embodiments, taken in conjunction with the accompanying drawings, of which:

FIG. 1 is a sectional view illustrating an inkjet print head according to an embodiment of the present general inventive concept;

FIG. 2 through FIG. 11 are sectional views illustrating manufacturing processes of an inkjet print head according to an embodiment of the present general inventive concept;

FIG. 12 is a sectional view illustrating a process wherein a hole of a notch prevention layer is formed simultaneously with a feed hole of a substrate in the inkjet print head according to an embodiment of the present general inventive concept; and

FIG. 13 and FIG. 14 are sectional views illustrating a process wherein a notch prevention layer is formed simultaneously with an electrode layer in an inkjet print head according to an embodiment of the present general inventive concept.

### DETAILED DESCRIPTION OF THE PREFERRED EMBODIMENTS

Reference will now be made in detail to an exemplary embodiment of the present general inventive concept, examples of which are illustrated in the accompanying drawings, wherein like reference numerals refer to like elements throughout. The embodiments are described below to explain the present general inventive concept by referring to the figures.

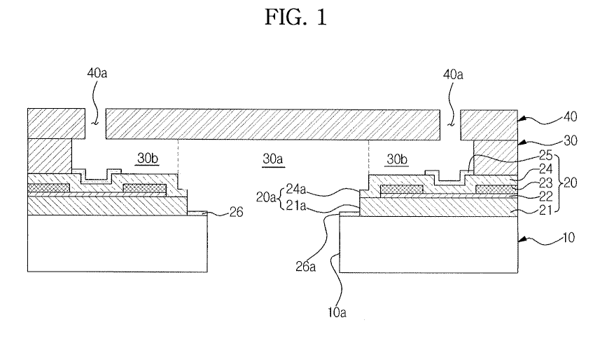

An inkjet print head according to an embodiment of the present general inventive concept is in a form of a thermal inkjet print head to generate bubbles in ink using a heat source and spouts ink droplets by expansive force of the bubbles. As illustrated in FIG. 1, the inkjet print head includes a substrate 10 serving as a supporting base of component parts of the inkjet print head, a path layer 30 deposited on the substrate 10, including ink paths 30a and 30b through which the ink is supplied, and a nozzle layer 40 deposited on the path layer 30 and provided with a nozzle 40a to emit the ink therethrough.

The substrate 10 includes a feed hole 10a to supply the ink. The ink paths 30a and 30b include an ink chamber 30a charged with the ink transferred through the feed hole 10a and a restrictor 30b to connect the ink chamber 30a with the nozzle 40a.

On the substrate 10 made of silicon, the feed hole 10a is formed through dry etching. The path layer 30 and the nozzle layer 40 are formed of a photosensitive polymer on a basis of epoxy, polyimide or acryl, and provided with the ink paths 30a and 30b and the nozzle 40a formed through photolithography, respectively.

In addition, a thin film lamination 20 is interposed between the substrate 10 and the path layer 30 to generate a jetting pressure enabling jetting of the ink through the nozzle 40a. The thin film lamination 20 includes a heat storing layer 21 formed on the substrate 20, a heat generating layer 22 formed on the heat storing layer 21, an electrode layer 23 formed on the heat generating layer 22, a passivation layer 24 formed on the electrode layer 23, and an anti-cavitation layer 25 formed on the passivation layer 24.

The thin film lamination 20 is formed with a penetration hole 20a serving as a path for the ink transferred through the feed hole 10a to be transferred to the ink paths 30a and 30b. The penetration hole 20a has a relatively greater width than the feed hole 10a, being constituted by a hole 21a of the heat storing layer 21 and a hole 24a of the passivation layer 24, the holes 21a and 24a having the same width.

The heat generating layer 22 includes a thin film heater formed of a high-resistance metal plate and disposed at an upper part of the substrate. The heat generating layer 22 heats the ink by converting electric signals transmitted through the electrode layer 23 to heat energy. The electrode layer 23 includes a low-resistance metal plate, such as Al, disposed at an upper part of the heat generating layer 22. The electrode layer 23 receives electric signals from a general CMOS logic or a power transistor, and transmits the electric signals to the heat generating layer 22. The passivation layer 24, being made of a SiNx layer having excellent insulating property and thermal conductivity, protects the heat generating layer 22 and the electrode layer 23 in contact with the heat generating layer 22 and the electrode layer 23. The anti-cavitation layer 25, which may be made of Ta, is disposed on the passivation layer 24 at a position corresponding to the nozzle 40a so as to prevent damage of the heat generating layer 22 caused by contracting shock generated as ink bubbles are burst by the heat energy. The heat storing layer 21 includes a silicon oxide layer and prevents loss of heat generated from the heat generating layer 22 by being transmitted to the substrate 10.

In addition, the inkjet print head further includes a notch prevention layer 26 to help the feed hole 10a maintain uniform width by restraining generation of notches that may be formed on the substrate 10 at positions adjoining the feed hole 10a while the feed hole 10a is being formed on the substrate 10 through dry etching.

The notch prevention layer 26 is formed of a conductive material to cover an area of the substrate 10 where the feed hole 10a will be formed. Therefore, the notch prevention layer 26 has a greater width than the feed hole 10a such that the feed hole adjoining part of the substrate 10 can remain covered with the notch prevention layer 26 even after the feed hole 10a is formed on the substrate 10. In this embodiment, the notch prevention layer 26 is disposed on the substrate 10 within a range of the penetration hole 20a formed at the thin film lamination 20. A thickness of the notch prevention layer 26 may be within a range of approximately 500 Å to 10,000 Å.

The notch prevention layer 26, by serving as a path for plasma electrons to pass through, prevents a generation of the notches at the feed hole adjoining part of the substrate 10. Therefore, with the notch prevention layer 26 formed of a conductive material and deposited on an area on one side of the substrate 10 where the feed hole 10a is to be formed, the plasma electrons flown into the feed hole 10a can flow through the notch prevention layer 26 and therefore, the feed hole adjoining part of the substrate 10 can be prevented from being corroded by the plasma electrons. Accordingly, notches would not be generated at the feed hole adjoining part of the substrate 10 and the feed hole 10a can have a uniform width all over.

Furthermore, since the generation of the notches is prevented by the notch prevention layer 26 as described above, although the dry etching to form the feed hole 10a on the substrate 10 is performed for a long time, the width of feed hole 10a can be maintained uniformly to correspond to a hole 26a of the notch prevention layer 26. Therefore, a long enough time can be allotted for the dry etching.

Hereinafter, a manufacturing method for the inkjet print head will be described with reference to the accompanying drawings.

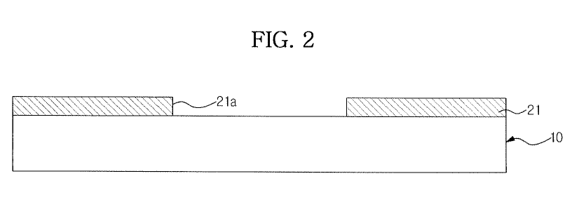

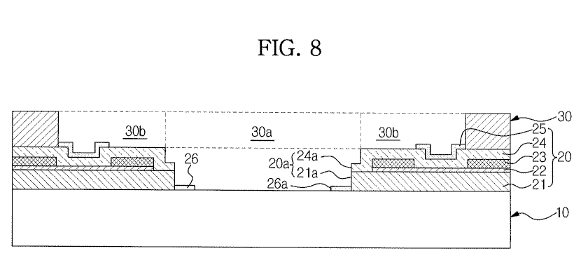

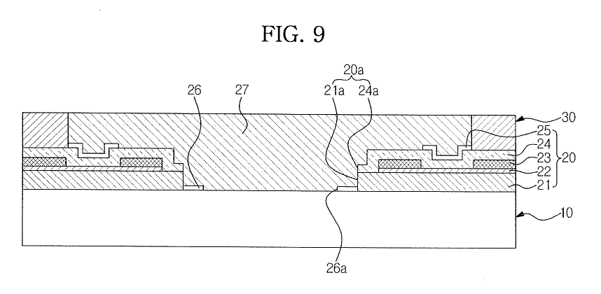

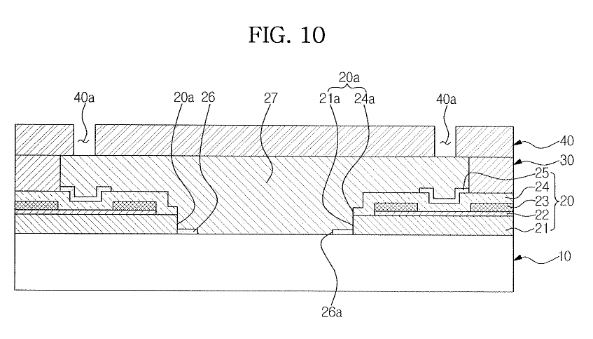

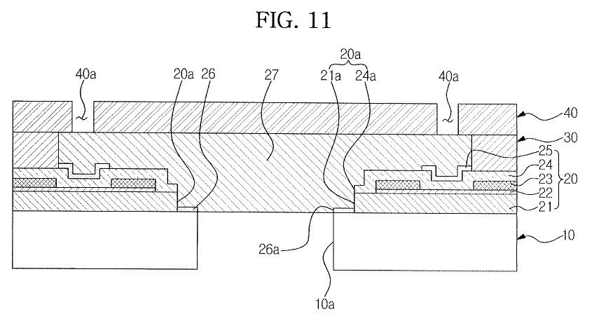

The inkjet print head is manufactured through the following operations. The substrate 10 made of silicon is prepared, and the thin film lamination 20 including the penetration hole 20a is formed on the substrate 10 (refer to FIG. 2 through FIG. 7). The path layer 30 including the ink paths 30a and 30b is formed on the thin film lamination 20 as illustrated in FIG. 8. The ink paths 30a and 30b of the path layer 30 are filled with a sacrifice layer 27 as illustrated in FIG. 9. The nozzle layer 40 including the nozzle 40a is deposited on the path layer 30 and the sacrifice layer 27 as illustrated in FIG. 10. The feed hole 10a is formed on the substrate 10 as illustrated in FIG. 11. Next, the sacrifice layer 27 in the ink paths 30a and 30b are removed, thereby completing manufacturing of the inkjet print head as illustrated in FIG. 1. Here, the feed hole 10a is formed through dry etching while the ink paths 30a and 30b formed at the path layer 30 and the nozzle 40a formed at the nozzle layer 40 are formed through photolithography.

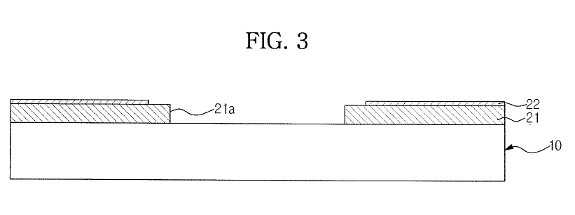

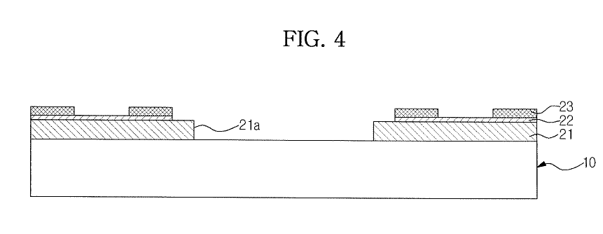

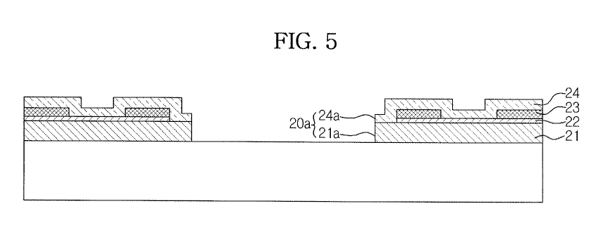

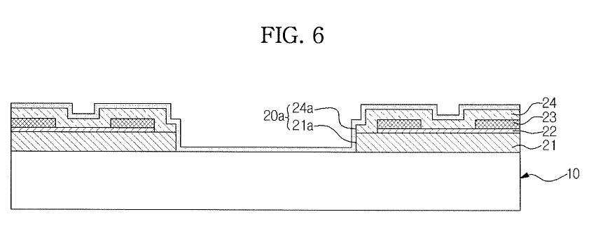

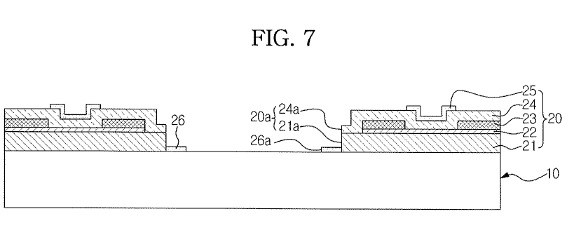

As illustrated in FIG. 2, more specifically, the thin film layer 20 is manufactured by forming on the substrate 10 the heat storing layer 21 having the hole 21a constituting part of the penetration hole 20a, forming the heat generating layer 22 on the heat storing layer 21 as illustrated in FIG. 3, forming the electrode layer 23 supplying electric power to the heat generating layer 22 on the heat generating layer 22 as illustrated in FIG. 4, forming on the electrode layer 23 the passivation layer 24 having the hole 24a constituting part of the penetration hole 20a as illustrated in FIG. 5, and forming the anti-cavitation layer 25 to protect the heat generating layer 22 on the passivation layer 24 as illustrated in FIG. 6 and FIG. 7. The penetration hole 20a of the thin film lamination 20 is constituted by forming the holes 21a and 24a respectively of the heat storing layer 21 and the passivation layer 24 to have the same width.

In addition, in order to prevent a generation of the notches at the feed hole adjoining part of the substrate 10 during the process of forming the feed hole 10a through dry etching, the inkjet print head manufacturing method further includes an operation of providing the notch prevention layer 26 made of a conductive material. The notch prevention layer 26 is formed to cover an area on one side of the substrate 10 where the feed hole 10a is to be formed. According to this embodiment, the notch prevention layer 26 is formed on the substrate 10 within a range of the penetration hole 20a of the thin film lamination 20.

In this embodiment, the notch prevention layer 26 is formed during a formation of the anti-cavitaion layer 25 together with the anti-cavitation layer 25. That is, as illustrated in FIG. 6, a Ta layer is formed on the passivation layer 24 and the substrate 10 and then patterned such that the notch prevention layer 26 and the anti-cavitation layer 25 are simultaneously formed as illustrated in FIG. 7. Here, since the notch prevention layer 26 is formed simultaneously with the anti-cavitation layer 25 through patterning, the notch prevention layer 26 is also made of Ta, that is, the same material as the anti-cavitation layer 25. While the notch prevention layer 26 is being formed together with the anti-cavitation layer 25, the hole 26a having a width corresponding to the feed hole 10a is formed.

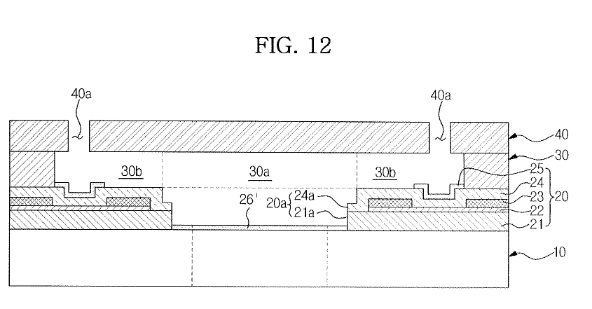

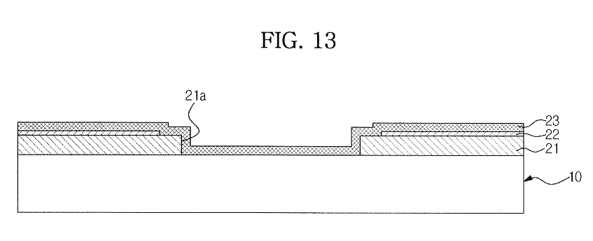

Although the notch prevention layer 26 is formed simultaneously with the anti-cavitation layer 25, and the hole 26a corresponding to the feed hole 10a is formed at the notch prevention layer 26 referring to FIG. 6 and FIG. 7, the present general inventive concept is not limited to this embodiment. Therefore, a notch prevention layer 26′ according to another embodiment of the present general inventive concept may be formed to cover the area to form the feed hole 10a thereon and partly removed through dry etching along a dotted-lined portion in FIG. 12, such that the hole 26a having the width corresponding to the feed hole 10 can be formed on the notch prevention layer 26′ while the feed hole 10a is being formed at the substrate 10.

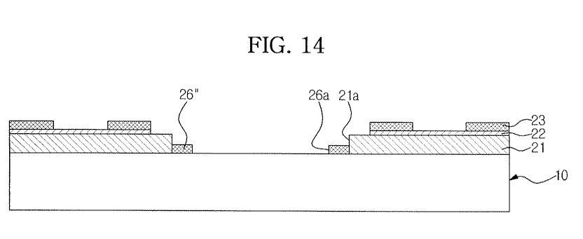

According to the embodiment of the present general inventive concept, the notch prevention layer 26 is formed together with the anti-cavitation layer 25 during formation of the anti-cavitation layer 25. However, the present general inventive concept is not limited to this method. While a conductive layer among the layers constituting the thin film lamination 20 is being formed, the notch prevention layer 26 may be formed together with the conductive layer. In other words, the notch prevention layer 26 in this embodiment is made of Ta, which is the same material as the anti-cavitation layer 25, since being formed together with the anti-cavitation layer 25. However, an Al layer may be formed on the substrate 10, the heat storing layer 21 and the heat generating layer 22 and then patterned as illustrated in FIG. 14 so that a notch prevention layer 26″ can be formed of Al along with the electrode layer 23.

In another embodiment, the notch prevention layer 26 may be separately formed at the substrate 10 after the thin film lamination 20 is completely formed.

Also, besides the metal such as Ta and Al as described above by way of examples, the notch prevention layer 26 may be formed of a conductive resin.

Furthermore, the notch prevention layer 26 remains on the substrate 10 even after the feed hole 10a is completely formed in this embodiment. However, according to the present general inventive concept, the notch prevention layer 26 may be removed after the feed hole 10a is formed.

As can be appreciated from the above description, since the inkjet print head according to the embodiment of the present general inventive concept is provided with a notch prevention layer to cover an area to form a feed hole thereon, electrons in a form of plasma guided into the feed hole are able to move through the notch prevention layer while the feed hole is being formed at the substrate through dry etching. Accordingly, notches generated at the substrate around the feed hole due to corrosion by the plasma electrons can be prevented. As a consequence, the feed hole can have a uniform width over all.

Furthermore, since corrosion of the feed hole adjoining part of the substrate is restrained by the notch prevention layer, an enough time for the dry etching for formation of the feed hole can be guaranteed.

Although embodiments of the present general inventive concept have been illustrated and described, it would be appreciated by those skilled in the art that changes may be made in this embodiment without departing from the principles and spirit of the general inventive concept, the scope of which is defined in the claims and their equivalents.

What is claimed is:

1. An inkjet print head, comprising:
a substrate formed with a feed hole through which ink is transferred; and
a notch prevention layer to cover an area on the substrate where the feed hole is to be formed.

2. The inkjet print head according to claim 1, wherein the notch prevention layer has a greater width than the feed hole.

3. The inkjet print head according to claim 2, wherein a thin film lamination is formed on the substrate, including a penetration hole having a greater width than the feed hole, and the notch prevention layer is formed on the substrate within a range of the penetration hole.

4. The inkjet print head according to claim 3, wherein the thin film lamination comprises:
a heat generating layer to generate heat; and
an electrode layer to supply power to the heat generating layer,
and the notch prevention layer is formed simultaneously with the electrode layer.

5. The inkjet print head according to claim 1, wherein the thin film lamination comprises:
a heat generating layer to generate heat; and
an anti-cavitation layer to protect the heat generating layer,
and the notch prevention layer is formed simultaneously with the anti-cavitation layer.

6. The inkjet print head according to claim 1, wherein the notch prevention layer has a width corresponding to the feed hole that will be formed at the substrate.

7. The inkjet print head according to claim 1,wherein the notch prevention layer has thickness in a range of 500 Åto 10,000 Å.

8. The inkjet print head according to claim 1, wherein the notch prevention layer is formed of a conductive material.

9. The inkjet print head according to claim 8, wherein the notch prevention layer comprises any one of Ta, Al, and a conductive resin.

10. An inkjet print head, comprising:
a substrate formed with a feed hole through which ink is transferred;
a thin film lamination formed on the substrate, including at least one conductive layer; and
a notch prevention layer formed with the conductive layer to cover an area on one side of the substrate where the feed hole is to be formed.

11. A manufacturing method of an inkjet print head, the method comprising:
preparing a substrate;
forming a notch prevention layer on the substrate; and
forming a feed hole through the substrate and the notch prevention layer through dry etching.

12. The manufacturing method according to claim 11, wherein a thin film lamination including at least one conductive layer is formed on the substrate, and
the notch prevention layer is formed along with the conductive layer.

13. The manufacturing method according to claim 12, wherein the thin film lamination includes a penetration hole to form a path, and
the notch prevention layer is formed on the substrate within a range of the penetration hole.

14. The manufacturing method according to claim 12, wherein the forming of the thin film lamination includes depositing an electrode layer which is a conductive layer, and
the notch prevention layer is formed along with the electrode layer.

15. The manufacturing method according to claim 12, wherein the forming of the thin film lamination includes depositing an anti-cavitation layer which is a conductive layer, and
the notch prevention layer is formed along with the anti-cavitation layer.

16. The manufacturing method according to claim 12, wherein, when the feed hole is formed on the substrate, the notch prevention layer is formed in a width corresponding to the feed hole.

17. The manufacturing method according to claim 11, wherein the notch prevention layer is removed after the feed hole is formed.

18. A manufacturing method of an inkjet print head, the method comprising:
forming a thin film lamination including at least one conductive layer, on a substrate;
forming a notch prevention layer along with the conductive layer; and
forming a feed hole through dry etching on an area of the substrate where the notch prevention layer is formed.

19. The manufacturing method according to claim 18, wherein the feed hole is formed through the substrate, and a hole having a width corresponding to the feed hole is formed on the notch prevention layer.

20. An inkjet print head, comprising:
a notch prevention layer to allow electrons to pass therethrough during formation of a feed hole having a width substantially uniform all over; and
a substrate having an area in which the feed hole is formed.

21. The inkjet print head according to claim 20, wherein the notch prevention layer covers the area of the substrate in which a feed hole is to be formed.

22. A method of manufacturing an inkjet print head, the method comprising:
forming a notch prevention layer on a portion of a substrate in which an ink feedhole is to be formed, the notch prevention layer comprising a material in which plasma electrons can pass therethrough; and
forming an ink feedhole through dry etching where the notch prevention layer is formed such that notches are not formed in the feedhole.
